(19) United States
(12) Patent Application Publication
(10) Pub. No.: US 2023/0168990 A1
(43) Pub. Date: Jun. 1, 2023

(54) IMAGE FORMING APPARATUS, CONTROL METHOD, AND PROGRAM

(71) Applicant: KONICA MINOLTA, INC., Tokyo (JP)

(72) Inventor: Shin OHBA, Toyokawa-shi (JP)

(73) Assignee: KONICA MINOLTA, INC., Tokyo (JP)

(21) Appl. No.: 18/049,884

(22) Filed: Oct. 26, 2022

(30) Foreign Application Priority Data
Nov. 29, 2021 (JP) 2021-193389

(51) Int. Cl. G06F 11/36; G06F 11/14

(52) U.S. Cl. CPC G06F 11/362; G06F 11/1451; G06F 11/1458

(57) ABSTRACT

An image forming apparatus includes: a converter that applies unidirectional one-to-one conversion to possible target data that has a possibility of becoming a target of legal regulations; and a log outputter that outputs a debug log including conversion result data obtained by the one-to-one conversion.

The entire disclosure of Japanese patent Application No. 2021-193389, filed on Nov. 29, 2021, is incorporated herein by reference in its entirety.

### BACKGROUND

### Technological Field

The present disclosure relates to an image forming apparatus, a control method, and a program, and particularly relates to improvement for smoothly performing bug verification of the program.

### Description of the Related Art

An image forming apparatus forms an image by an electrophotographic method or an inkjet method. For example, image formation by an electrophotographic method includes a series of steps such as exposure of a photoreceptor, development of an electrostatic latent image obtained by the exposure, transfer of a toner image obtained by the development to a sheet, and fixing of the transferred toner image. A computer of the image forming apparatus executes an operating system and an application for securing a basic function as an information device in addition to firmware for controlling the image forming process. Since it is necessary to develop these firmware and applications and to maintain quality, a burden of software development on a manufacturer that develops the image forming apparatus tends to increase year by year.

To smoothly perform failure analysis and debugging of a program, a debug log has been conventionally used. The debug log is a log indicating what kind of processing was performed inside each program and what the input value and output value were, and it is possible to output the debug log by inserting a dedicated debug log output code into the program. By tracing a series of debug logs, it is possible to follow the operation of the program, and it is possible to efficiently identify the cause of a failure of the firmware or the application and perform debugging.

Meanwhile, the debug log may include data that can be a target of legal regulations. Typical data that can be the target of legal regulations is personal information. The personal information includes various types such as a name, an identification number, location data, an email address, and an online identifier of a natural person. It has become a topic of industry that processing and transfer of these pieces of personal information outside the European Economic Area (EEA) are regulated by General Data Protection Regulation (hereinafter referred to as GDPR) in the EEA.

An information processing apparatus capable of generating a debug log while protecting information unsuitable for release is described in JP 2010-147942 A. The information processing apparatus analyzes an argument character string notified from a debug target program, performs masking processing, and generates a debug log including the masked argument character string. The mask processing here refers to replacing some characters constituting the argument character string with the aster risk character “*”. For example, the argument character string of “03-4567-8901” is masked, and the debug log of “Telephone Number: ***4***-***1” is output. In this example, the number of consecutive characters to be masked is set to =3, and the number of consecutive characters not to be masked is set to 1. Both the number of consecutive characters to be masked and the number of consecutive characters not to be masked can be changed.

However, in the above-described conventional technique, if the number of consecutive characters to be masked is small, the original argument character string may be estimated, and thus the personal information cannot be sufficiently protected.

However, if the number of consecutive characters to be masked is increased, a problem as follows occurs.

For example, the debug log of a login processing program may include a login name and a password in the debug log. In such a case, when the number of consecutive characters to be masked is increased, the login name that has been correctly input and the login name that has been erroneously input may be converted into the same character string by the mask processing, and it may be impossible to distinguish whether the reason for a login failure is due to the erroneous input of the login name or due to a bug in the login processing program from the contents of the debug log.

If the login name is erroneously input, it is not necessary to debug the login processing program, but if the login processing program has a bug, a countermeasure is required. The debug log is for analyzing the operation of the program to be debugged, including the determination of necessity of debugging in this manner, and is required to achieve both the original purpose of the debug log and the protection of personal information.

Such a request is similarly applied to protection of programs other than the login processing program and personal information other than the login name. In addition, even data other than personal information may be required to be protected by laws and regulations.

### SUMMARY

An object of the present disclosure is to provide an image forming apparatus capable of protecting data that can be subject to legal regulations without impairing analyzability of a program operation using a debug log.

To achieve the abovementioned object, according to an aspect of the present invention, an image forming apparatus reflecting one aspect of the present invention comprises: a converter that applies unidirectional one-to-one conversion to possible target data that has a possibility of becoming a target of legal regulations; and a log outputter that outputs a debug log including conversion result data obtained by the one-to-one conversion.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a program debug system;

FIG. 2 illustrates a hardware configuration of an image forming apparatus;

FIG. 3 illustrates a program installed in an HDD;

FIG. 4 illustrates user names (NAKATA, NISIDA, and KAWATA) stored in an NVRAM and email addresses (nakata@abc.jp, nisida@abc.jp, and kawata@abc.jp) registered by these users;

FIG. 5 illustrates a state in which a Panel application, a Login application, a Send application, a Backup application, and an Authdevice application are loaded into a RAM and provided in a multi-task execution environment;

FIG. 6A illustrates an example of a template file;

FIG. 6B illustrates an example of a variable area;

FIG. 7 is a flowchart illustrating a processing procedure to be performed with a log processing code;

FIG. 8A illustrates a login screen;

FIG. 8B illustrates a debug log generated when login succeeds;

FIG. 8C illustrates a login screen on which a user name is erroneously input;

FIG. 8D illustrates a debug log generated when the login fails;

FIG. 8E illustrates an example of correspondence between the user names and hash values;

FIG. 9A illustrates a case where an email address is input by an operation on an email address screen;

FIG. 9B illustrates a debug log generated when email transmission succeeds;

FIG. 9C illustrates a case where an email address is input by an operation on the email address screen;

FIG. 9D illustrates an example of a debug log generated when email transmission fails;

FIG. 10 illustrates an example of a hash value table;

FIG. 11 is a flowchart illustrating a processing procedure to be executed in a second embodiment;

FIG. 12A illustrates debug logs using DATA001 to DATA003;

FIG. 12B illustrates debug logs using DATA001 to DATA003;

FIG. 13A illustrates a debug log generated when login is OK; and

FIG. 13B illustrates a debug log generated when login is NG.

### DETAILED DESCRIPTION OF EMBODIMENTS

Hereinafter, one or more embodiments of an image forming apparatus of the present invention will be described with reference to the drawings. However, the scope of the invention is not limited to the disclosed embodiments.

### First Embodiment

### [1] External Appearance of Image Forming Apparatus 1

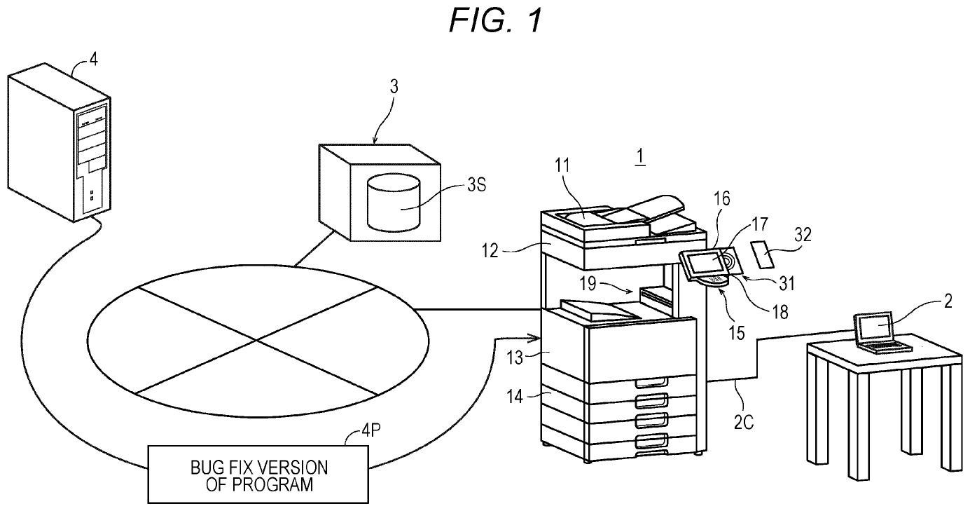

An image forming apparatus according to the present disclosure is used in the program debug system illustrated in FIG. 1. The program debug system includes an image forming apparatus 1, a personal computer (PC) 2, a server 3 of a program development department, and a program providing server 4.

The image forming apparatus 1 is a tandem color multifunction peripheral (MFP) that performs image formation by an electrophotographic method, and includes a document conveying unit 11, a scanner unit 12, a printer unit 13, a sheet feeding unit 14, and an operation unit 15. The document conveying unit 11 sends documents placed on a tray at the top of the apparatus one by one to the scanner unit 12, and the scanner unit 12 optically reads characters and the like recorded on the document. The printer unit 13 forms an image on a sheet supplied from the sheet feeding unit 14 and outputs the printed sheet from an ejection port 19. The operation unit 15 includes a display unit 16, a touch panel 17, and a key unit 18.

The display unit 16 is a liquid crystal display or the like, is provided on a front side of the image forming apparatus, and displays information regarding a job and other information to the user.

The touch panel 17 covers a surface of the display unit 16 and outputs coordinates of a position touched by the user in the display unit 16.

The key unit 18 includes a key for receiving a start operation and a stop operation, a key for receiving job selection, and a keyboard for receiving input of alphabets from A to Z, and receives a job start instruction, a job stop instruction, and input of characters of a user name and an email address.

When an inconvenience occurs in the image forming apparatus 1, a service person who has made a visit by a service person call from the user collects a debug log created by the image forming apparatus 1 using a PC 2. As a method of recovering the debug log, there are a method of connecting the image forming apparatus 1 and the PC 2 with a serial cable 2C and fetching the debug log terminal-output by the image forming apparatus 1, a method of connecting the PC 2 to the image forming apparatus 1 by a USB connector (not illustrated) of the image forming apparatus 1 and transferring a file of the debug log from the image forming apparatus 1 to the PC 2, and a method of copying the file of the debug log generated on a memory of the image forming apparatus 1 to a recording medium such as a USB memory and delivering the file of the debug log from the recording medium to the PC 2 via the recording medium.

The service person transfers the debug log collected by the PC 2 to the server 3 of the program development department, and accumulates the debug log in the storage 3S of the server 3. A person in charge of debugging of the development department refers to the debug log and the source code of the program of the image forming apparatus 1 to verify whether or not the inconvenience that has caused the service person call is due to a bug in the program. If the cause of the inconvenience is a bug, a version of the program in which the bug is corrected is created and supplied to the program providing server 4. The image forming apparatus 1 downloads a bug fix version of the program 4P provided by a person in charge of debugging from the program providing server 4, replaces the program installed in the image forming apparatus 1 with the bug fix version of the program, and achieves version upgrade.

A problem in the above debugging process is that data that can be a target of legal regulations in the above debug log collection process is included in the debug log. The legal regulations are national laws and regulations, implementing rules of national laws and regulations, local regulations, conventions, international agreements, and rules that impose some kind of regulation on leakage of information to the outside, and include various laws and regulations such as the GDPR, the Personal Information Protection Act of Japan, and the Act on Disclosure of Information Owned by Administrative Organs (Information Disclosure Act), the insider trading prohibition law system, the patient protection law system, the law for protecting business information, and the like. When debug logs accumulated in the server 3 of the development department include data that can be a target of legal regulations, the manufacturer of the image forming apparatus 1 may be legally responsible for violating the legal regulations. Data that can be a target of legal regulations in this manner is referred to as possible target data. The possible target data includes both data that is clearly subject to laws and regulations and data that is partially different from the regulation target data and is similar to the regulation target data.

Accordingly, when outputting the debug log, the image forming apparatus 1 performs unidirectional conversion on the possible target data (including the regulation target data) so that the original data is not specified from the debug log. Note that, the description becomes complicated if all the laws and regulations are described, and thus the following description will be given targeting the GDPR as a representative legal system. Specifically, the possible target data includes data (personal data) corresponding to personal information and data similar to the personal data. Further, it is assumed that the regulation target data is personal data.

### [2] Hardware Configuration of Image Forming Apparatus 1

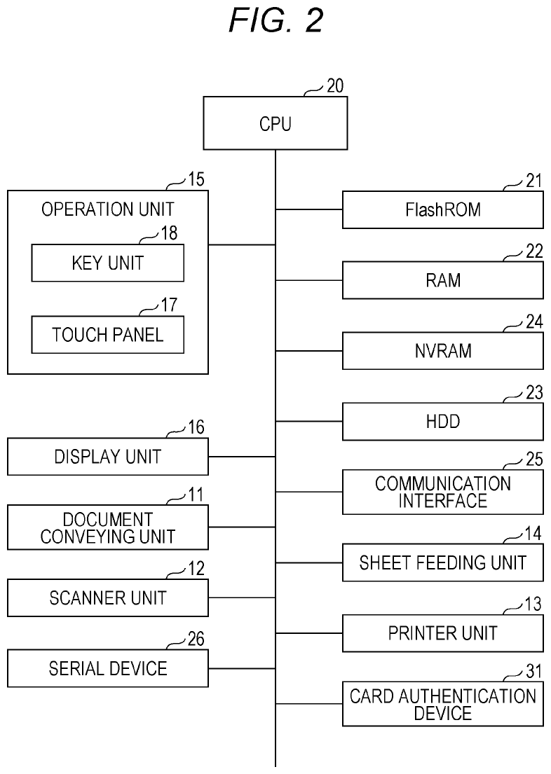

FIG. 2 illustrates a hardware configuration of the image forming apparatus 1. As illustrated in the drawing, the image forming apparatus 1 includes a CPU 20, a flash ROM 21, a RAM 22, an HDD 23, an NVRAM 24, a communication interface 25, and a serial device 26, and is connected to a card authentication device 31.

When the power of the image forming apparatus 1 is turned on, the CPU 20 reads a program installed in the flash ROM 21 or the HDD 23 into the RAM 22 and executes the program, thereby implementing basic functions of the image forming apparatus 1. Such basic functions include document conveyance by the document conveying unit 11, document reading by the scanner unit 12, sheet feeding by the sheet feeding unit 14, image formation by the printer unit 13, operation input from the operation unit 15, and screen output to the display unit 16. The program installed in the flash ROM 21 is a plurality of control programs constituting firmware, and causes the document conveying unit 11, the scanner unit 12, the printer unit 13, the sheet feeding unit 14, the operation unit 15, and the display unit 16 to implement the basic functions described above. The CPU 20 has an execution mode for executing these programs and an output mode for debugging. The execution mode and the output mode for debugging can be switched by setting of a dual switch when the service person makes a visit.

There are two types of communication units, the communication interface 25 and the serial device 26. The communication interface 25 includes an NIC, a modem, a TA, and a wireless LAN card for transmitting and receiving data to be printed and data read by the scanner unit 12. The serial device 26 is a communication unit for connecting to the external PC 2 through the serial cable 2C when the CPU 20 is switched to the debug mode and outputs a terminal for debugging, and can output a debug log to the outside through the serial device 26.

### [3] Program Installed in HDD 23

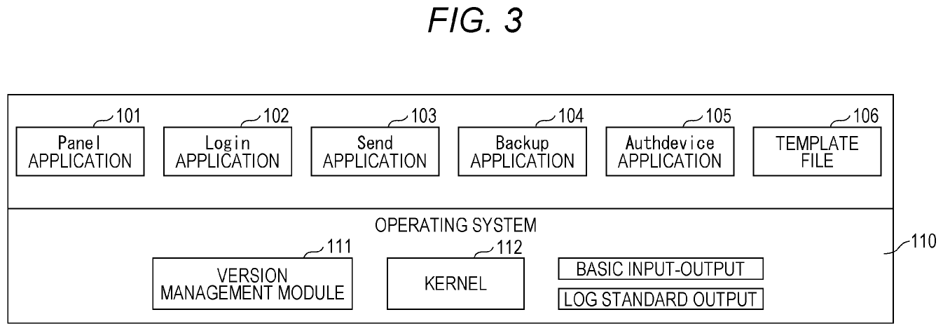

The program installed in the HDD 23 is illustrated in FIG. 3. As illustrated in the drawing, an operating system 110 and an application thereof are installed in the HDD 23, and a corresponding template file is stored therein. The applications include a Panel application 101, a Login application 102, a Send application 103, a Backup application 104, and an Authdevice application 105. A debug log template file 106 is stored in advance together with these applications. As will be described in detail later, the template file 106 achieves debug log creation by the Panel application 101, the Login application 102, and the like.

The operating system 110 includes a version management module 111 and a kernel 112.

The version management module 111 accesses the program providing server 4 to check whether the latest version of the firmware or the application is supplied, and if the latest version is supplied, the latest version of the firmware or the application is downloaded to upgrade the firmware installed in the flash ROM 21.

The kernel 112 manages individual applications and control programs loaded into the RAM 22 as tasks, and controls operations of a plurality of applications under a multitasking execution environment.

(3-1) Information Necessary for Implementation of Basic Functions

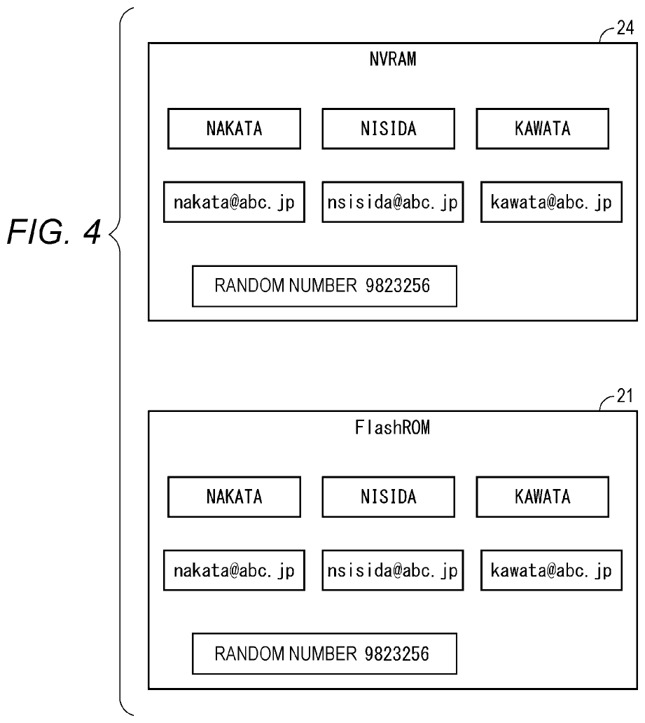

Information necessary for implementing the basic functions is registered in the NVRAM 24. The NVRAM 24 is a ferroelectric random access memory or the like, and has an advantage over the flash ROM 21 in that high-speed writing is possible. The NVRAM 24 stores various regulation target data. As illustrated in FIG. 4, the regulation target data includes a user name (NAKATA, NISIDA, and KAWATA) of a user who can log in to the image forming apparatus 1 and perform an operation, and an email address (nakata@abc.jp, nisida@abc.jp, and kawata@abc.jp) registered by the user. In addition, a calculation constant (9823256) assigned to the image forming apparatus 1 is stored. The calculation constant is a numerical value assigned to each image forming apparatus when the manufacturer of the image forming apparatus produces the image forming apparatus in units of several 1000 or several tens of thousands. In the present embodiment, when shipping each of the plurality of manufactured image forming apparatuses, the manufacturer of the image forming apparatus generates random numbers, assigns each value of the random numbers to the image forming apparatus, and writes the value in the NVRAM 24 as the calculation constant unique to the apparatus.

Since the regulation target data (user name, email address) stored in the NVRAM 24 and the random number which is a constant unique to the device are important data, backup is periodically performed by the above-described Backup application 104, and the same user name and email address are written in the flash ROM 21. By periodically copying the regulation target data such as the user name and the email address stored in the NVRAM 24 to the flash ROM 21 and backing up the user name and the email address in the flash ROM 21, even if an abnormality occurs in the NVRAM 24, recovery can be performed by copying the regulation target data such as the user name and the email address from the flash ROM 21 to the NVRAM 24.

(3-2) Configuration of Task Corresponding to Application

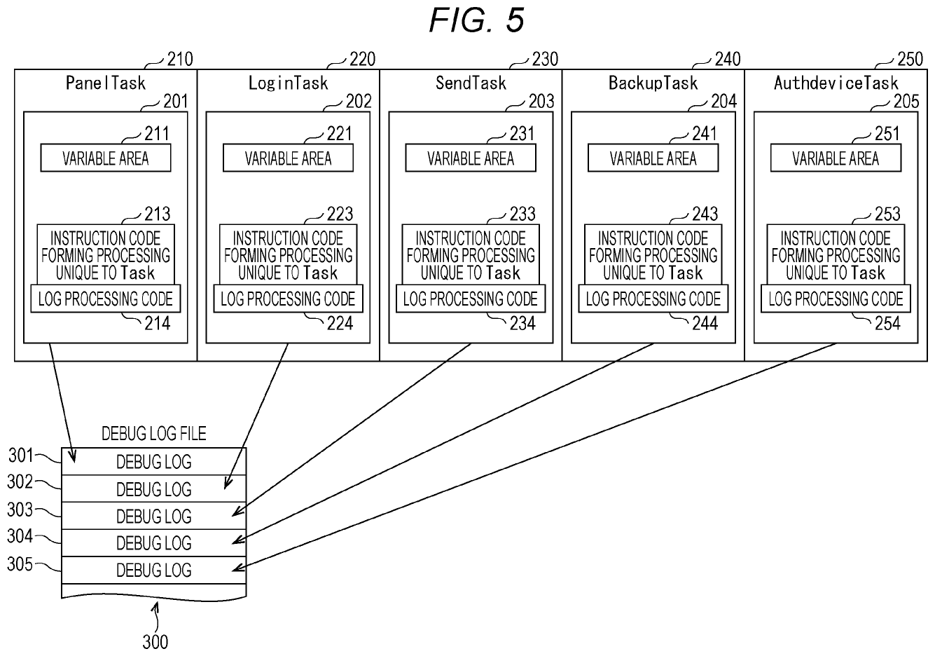

FIG. 5 illustrates a state in which the Panel application 101, the Login application 102, the Send application 103, the Backup application 104, and the Authdevice application 105 are loaded into the RAM 22 and provided in a multitasking execution environment.

A task (PanelTask 201) corresponding to the Panel application 101, a task (LoginTask 202) corresponding to the Login application 102, a task (SendTask 203) corresponding to the Send application 103, a task (BackupTask 204) corresponding to the Backup application 104, and a task (AuthdeviceTask 205) corresponding to the Authdevice application 105 are arranged in each of partial areas 210, 220, 230, 240, and 250 of the RAM 22. These tasks have a common configuration, and include variable areas 211, 221, 231, 241, and 251 for respective tasks, instruction codes 213, 223, 233, 243, and 253 forming processing unique to the tasks, and log processing codes 214, 224, 234, 244, and 254. These tasks operate with issuance of an interrupt signal to the CPU 20 as a trigger.

The log processing codes 214, 224, 234, 244, and 254 output debug logs 301, 302, 303, 304, and 305 indicating processing contents performed by the respective tasks and processing results thereof. When the output destination of the debug logs is set to a file in the log processing code, the debug logs output by the log processing code can be stored in one file 300 and delivered to the PC 2 of the service person. In a case where the application is created using a high-level programming language of the C language system, the debugging output can be described using, for example, an output function such as a fprinff function.

(3-3) Configuration of Template File 106

The generation of the debug logs by the log processing codes 214, 224, 234, 244, and 254 is performed using the template file 106 illustrated in FIG. 3. The template file 106 is a fixed phrase indicating typical processing contents performed by each task using various variables.

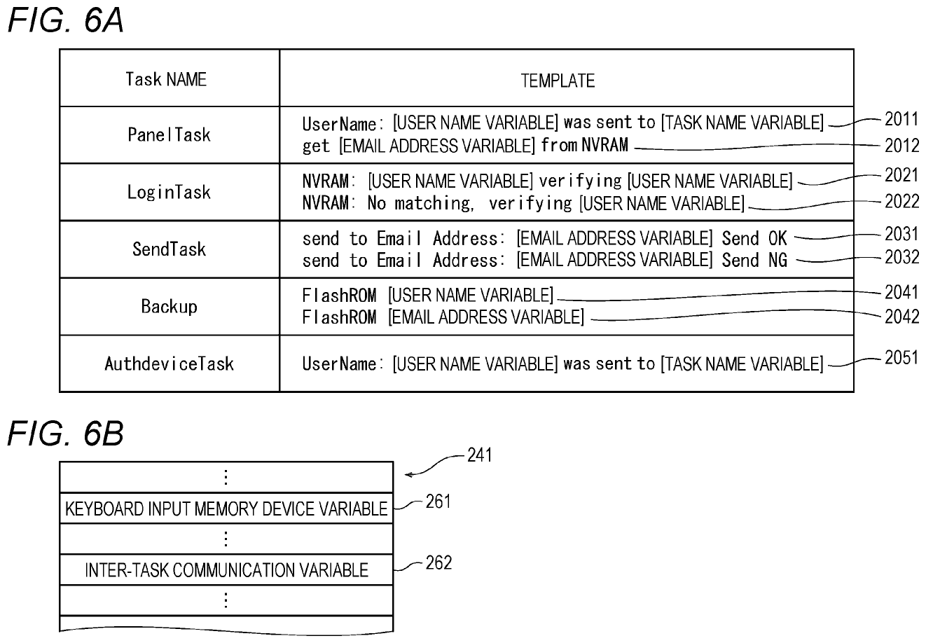

The log processing codes 214, 224, 234, 244, and 254 included in each application express processing contents performed by the application by selecting a template according to the processing contents performed by the application and applying a specific character string to a variable of the template. FIG. 6A illustrates an example of the template file 106 representing processing contents using a personal data storage variable. The personal data storage variable is a variable for storing the regulation target data or the possible target data. Hereinafter, the contents of the debug log template for representing the processing contents of each of the PanelTask 201 to the AuthdeviceTask 205 will be described.

The PanelTask 201 displays a login screen or an email address selection screen, and acquires a character string input by typing the keys of the key unit 18 when the login screen is displayed or an email address selected on the email address selection screen. Since different processing is performed between when the login screen is displayed and when the email address selection screen is displayed, the template 2011 and the template 2012 illustrated in FIG. 6A are associated with the PanelTask 201. The first template 2011 is UserName: [user name variable] was sent to [task name variable], and indicates that the value of the user name variable, which is the first variable, is passed to the task of the task name variable, which is the second variable. The second template 2012 is get [email address variable] from NVRAM and indicates that the email address is acquired from the NVRAM 24. The user name variable of the template 2011 is a variable for storing the possible target data, and data similar to the regulation target data may be stored due to erroneous input or the like. The email address variable of the template 2012 is a variable for storing the regulation target data.

The LoginTask 202 is a task of acquiring a character string corresponding to the user name from PanelTask and AuthdeviceTask and collating the character string with a plurality of user names registered in the NVRAM 24, and two templates 2021 and 2022 are associated with each other. The first template 2021 is NVRAM: [user name variable] verifying [user name variable], and indicates that the input user name is authenticated by the user name stored in the NVRAM 24. The second template 2022 is NVRAM: No matching, verifying [user name variable], and indicates that the input user name is not authenticated by any user name stored in the NVRAM 24. The user name variable of the templates 2021 and 2022 is a variable for storing the possible target data, and data similar to the regulation target data may be stored due to erroneous input or the like.

The SendTask 203 is a task of transmitting an email to which image data read by the scanner unit 12 is attached with an email address selected by the user on the email address screen as a destination, and two templates are associated. The first template 2031 is send to Email Address: [email address variable] Send OK, and indicates that an email is transmitted to the destination defined in the email address variable and the email has reached the destination. The second template 2032 is send to Email Address: [email address variable] Send NG, and indicates that an email is transmitted to the destination defined in the email address variable and the email has not reached the destination. The email address variable of the templates 2031 and 2032 is a variable for storing the regulation target data.

The BackupTask 204 is a task of periodically writing the user name and the email address stored in the NVRAM 24 to the flash ROM 21, and two templates 2041 and 2042 are associated with each other. The first template 2041 is FlashROM [user name variable], and indicates that the user name of the user name variable part has been written in the flash ROM 21 and backed up. The second template 2042 is FlashROM [email address variable], and indicates that the email address of the user name variable is written in the flash ROM 21 and backed up. The email address variable of the templates 2041 and 2042 is a variable for storing the regulation target data.

The interval at which the user name and the email address are written in the flash ROM 21 is determined in advance by an administrator.

The AuthdeviceTask 205 is a task of acquiring the user name read from the personal card 32 by the card authentication device 31, and is associated with one template 2051, that is, [user name variable] was sent to [task name variable]. This template indicates that the user name is acquired from the card authentication device 31 and passed to the task of the task name variable. The user name variable of the template 2051 is a variable for storing the possible target data.

The template in FIG. 6A merely illustrates a template file 106 representing processing contents using a user name or an email address. Some processing contents performed by the PanelTask 201 to the AuthdeviceTask 205 do not use a user name or an email address, and a template of the processing contents not using the user name or the email address indicates the processing contents using a variable that is not the personal data storage variable. It should be noted that a template indicating processing contents using a variable that is not the personal data storage variable is not a subject of the present application, and thus is not illustrated.

(3-4) Acquisition of Character String to be Applied to Template

When representing the processing content of each task in the templates 2011, 2012, 2121, 2022, 2031, and 2032, the character string to be applied to the user name variable is acquired from the variable area of each task. An example of the variable area is illustrated in FIG. 6B. As illustrated in the drawing, the variable area includes a key input memory device variable 261 for receiving a character string input to the keyboard of the key unit 18, and an inter-task communication variable 262 for input and output with another task.

### [4] Processing to be Performed by Log Processing Codes 214 to 254

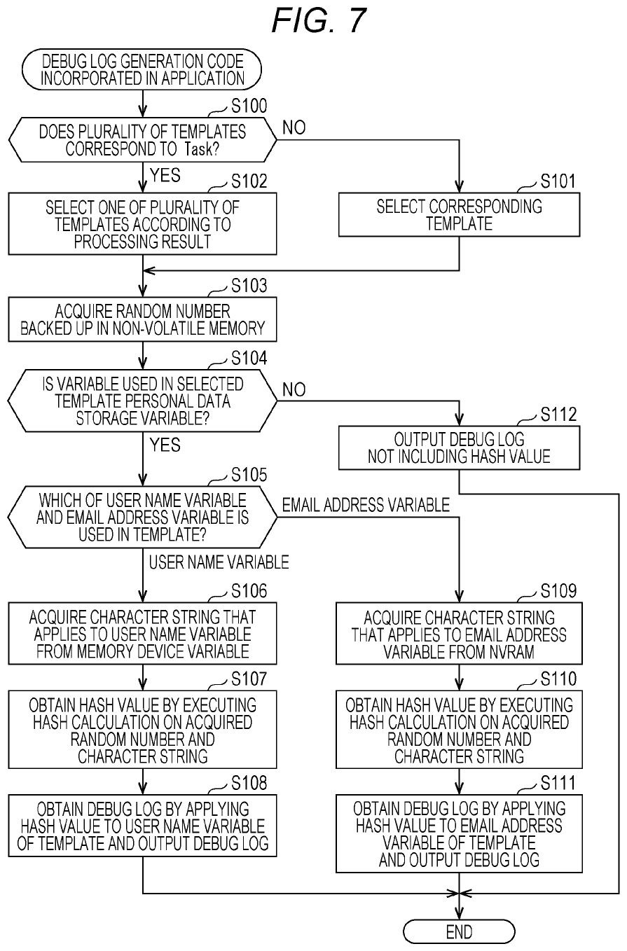

A processing procedure to be performed with the log processing code is as illustrated in FIG. 7.

It is determined whether a plurality of templates corresponds to the task including the log processing code (step S100), and when the plurality of templates does not correspond to the task (No in step S100), a corresponding template is selected (step S101). When the plurality of templates corresponds (Yes in step S100), one of the plurality of templates is selected according to the processing result (step S102).

A random number which is a constant unique to the device and stored in the flash ROM 21 is acquired (step S103). The random number is recorded in both the flash ROM 21 and the NVRAM 24, but here, the random number is acquired from the flash ROM 21. This is because the flash ROM 21 has higher stability.

In the above process, the template selected in steps S101 and S102 indicates processing performed in the corresponding task. The variables used in the template selected in steps S101 and S102 include the personal data storage variable and other variables as described above.

In step S104, it is determined whether or not the variable used in the template selected in step S102 is the personal data storage variable, to thereby determine whether the personal data to be regulated by the GDPR law is processed in the corresponding task.

When the variable used for the selected template is not the personal data storage variable, No is selected in step S104, the processing proceeds to step S112, and the debug log representing the processing content of the corresponding task is generated without using the hash value and output (step S112).

When the variable used for the selected template is the personal data storage variable, Yes is selected in step S104, and the processing proceeds to step S105. In step S105, it is determined whether the personal data storage variable in the template is the user name variable or the email address variable.

When the variable used in the template is the user name variable (the user variable in step S105), the character string of the user name to be applied to the user name variable is acquired from the key input memory device variable 261 (step S106), and the hash value is obtained by executing the hash function on the acquired random number and character string (step S107). The hash function is a function that maps a value x of a certain key to a certain value range such as a subscript set of an array, and a value returned by the hash function is referred to as a hash value. In the present embodiment, a hexadecimal numeric value representing the user name or the email address is used as the value of the key. The key value is multiplied by a coefficient unique to the device and applied to Message Digest Algorithm 5 (MD5) that is a representative hash algorithm to obtain a hash value. The hash algorithm has a property that the output hash value greatly changes when the hexadecimal numeric value as a key is different even by 1 bit, and is used for alteration detection.

The debug log is obtained and output by replacing the user name variable of the template with the obtained hash value (step S108).

When the variable used in the template is the email address variable (mail address variable in step S105), a character string of an email address to be applied to the email address variable is acquired from the NVRAM 24 (step S109), and a hash value is obtained by executing a hash function on the acquired random number and the character string (step S110). Then, by replacing the email address variable of the template with the hash value, the debug log is obtained and output (step S111).

The random number, the user name, and the email address, which are constants unique to the device, are stored in the NVRAM 24 and the flash ROM 21, but it is desirable to acquire the random number, the user name, and the email address from the flash ROM 21 upon generating the debug log. This is because the flash ROM 21 is more stable as a storage device.

In addition, when the conversion by the hash function is executed on the user name and the email address in steps S108 and S111, it is desirable that the hash value obtained by the conversion is written in the NVRAM 24 and the flash ROM 21 in association with the user name and the email address, and the conversion result by the hash function is stored in association with the user name and the email address. In this way, when the same user name and the same email address are converted, it is desirable to read the hash value stored in advance in the NVRAM 24 and the flash ROM 21 and omit the conversion by the hash function instead of the processing of steps S105 to S111.

### [5] Process of Generating Debug Log by Debug Log Generation Code for Each Task

(5-1) Debug Log Generated at Time of Key Input on Login Screen

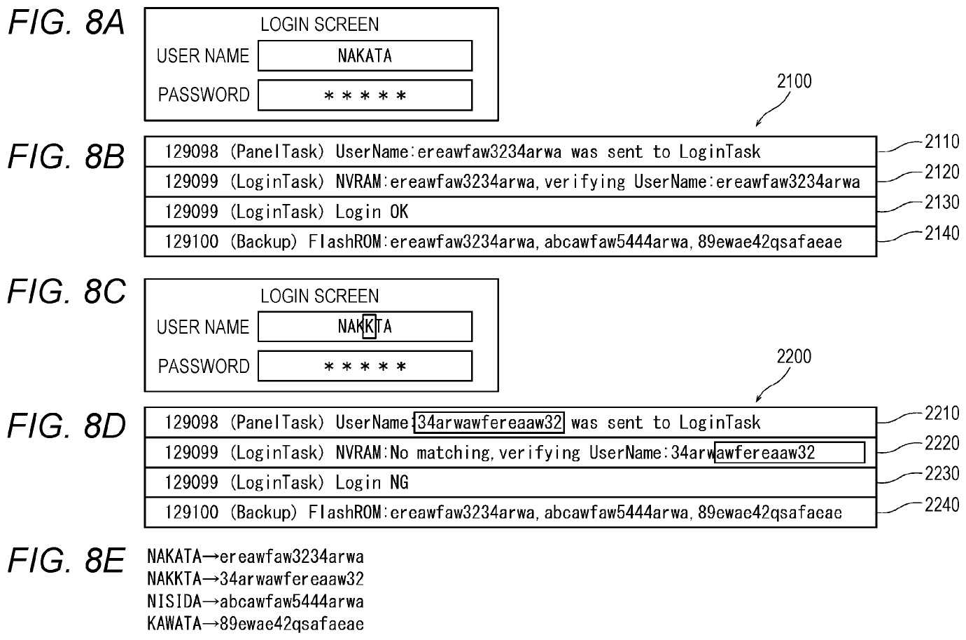

A process of generating a debug log by each of the log processing codes 214 to 254 will be described. As illustrated in FIG. 8A, it is assumed that the user opens the login screen and key-inputs NAKATA which is one of a plurality of user names stored in the NVRAM 24. In this case, since the character string input by typing the keys of the key unit 18 is stored in the key input memory device variable 261, the PanelTask 201 copies the address of the key input memory device variable 261 to the inter-task communication variable 262, thereby passing the character string obtained by typing of the keys of the key unit 18 to the LoginTask 202.

Since the character string NAKATA input from the key unit 18 is a user name, the log processing code 214 included in the PanelTask 201 selects the first template 2011, that is, UserName: [user name variable] was sent to [task name variable]. (step S102), and acquires a character string of NAKATA from the key input memory device variable 261 as a character string to be applied to the portion of [user name variable] (step S106).

Furthermore, since the PanelTask 201 displays the login screen of FIG. 8A, LoginTask is applied as a default task name for [task name variable]. The hash value is calculated from the character string acquired in this manner and the random number, and the user name variable of the template 2011 is replaced with the hash value ereawfaw3234arwa, so that a debug log 2110 of FIG. 8B, that is, (PanelTask) UserName: ereawfaw3234arwa was sent to LoginTask is obtained.

Since the character string NAKATA input from the key unit 18 is one of the user names stored in the NVRAM 24 and the user name is authenticated, the log processing code 224 included in the LoginTask 202 selects the first template 2021, that is, NVRAM: [user name variable] verifying [user name variable] (step S102), and acquires a character string of NAKATA from the key input memory device variable 261 as a character string to be applied to the portion of [user name variable] (step S106). The hash value is calculated from the character string acquired in this manner and the random number, and the hash value ereawfaw3234arwa is applied to the user name variable of the template. Thus, debug logs 2120 and 2130 in FIG. 8B, that is, (LoginTask) NVRAM: ereawfaw3234arwa, verifying UserName: ereawfaw3234arwa, and (LoginTask) Login OK are obtained.

Since the user name is authenticated in the BackupTask 204, the log processing code 244 included in the BackupTask 204 selects the first template 2041, that is, the FlashROM [user name variable] (step S102), and acquires character strings of NAKATA, NISIDA, and KIMURA as character strings to be applied to the portion of [user name variable] (step S106). The hash value is calculated from the character string acquired in this manner and the random number, and the hash values ereawfaw3234arwa, abcawfaw5444arwa, 89ewae42qsafaeae are applied to the user name variable of the template. Thus, a debug log 2140 of FIG. 8D, that is, (Backup) FlashROM: ereawfaw3234arwa, abcawfaw5444arwa, 89ewae42qsafaeae is obtained.

Next, as illustrated in FIG. 8C, a case where the user tries to input one of a plurality of user names NAKATA stored in the NVRAM 24 but erroneously inputs NAKKTA will be described. Since the character string NAKKTA input from the key unit 18 is a user name, the log processing code included in the PanelTask 201 is selected as the first template 2011, that is, UserName: [user name variable] was sent to [task name variable]. (step S102), and a character string of NAKKTA is acquired from the key input memory device variable 261 as a character string to be applied to the portion of [user name variable] (step S106). A hash value 34arwawfereaaw32 is calculated from the character string acquired in this manner and the random number, and the hash value is assigned to the user name variable of the template to obtain a debug log 2210 of FIG. 8D, that is, (PanelTask) UserName: 34arwawfereaaw32 was sent to LoginTask.

Since the character string NAKKTA input from the key unit 18 is different from any of the user names stored in the NVRAM 24 and the authentication of the user name fails, the log processing code included in the LoginTask 202 selects the second template 2022, that is, NVRAM: Nomatching, verifying [user name variable] (step S102), and acquires a character string of NAKKTA from the key input memory device variable 261 as a character string to be applied to the portion of [user name variable] (step S106). The hash value 34arwawfereaaw32 is calculated from the character string acquired in this manner and the random number, and the hash value is applied to the user name variable of the template. Thus, a debug log 2220 of FIG. 8D, that is, NVRAM: No matching, verifying UserName: 34arwawfereaaw32 is obtained.

The processing of the BackupTask 204 is similar to that in FIG. 8B. Through the above processing, in FIG. 8A, the debug logs 2110, 2120, 2130, and 2140 of FIG. 8B are obtained in the case where the login is successful, and in FIG. 8C, the debug logs 2210, 2220, 2230, and 2240 are obtained in the case where the login is unsuccessful. In the above process, the character strings of NAKATA, NISIDA, and KAWATA are replaced with character strings of ereawfaw3234arwa, abcawfaw5444arwa, and 89ewae42qsafaeae, respectively, as illustrated in FIG. 8E. The NAKKTA character string input by erroneous input is replaced with a character string different from NAKATA, that is, 34arwawfereaaw32. Consequently, in the debug log of FIG. 8D, since the character string of the input error of NAKKTA is expressed by a hash value different from any of NAKATA NISIDAKAWATA, (LoginTask) NVRAM:

No matching, verifying, LoginTask) Login NG of the debug log 2240 of the debug logs 2230 and 2240 is caused by an erroneous input of the operation unit 15, and it is possible to give a determination result that there is no problem in the Panel application 101 and the Login application 102.

(5-2) Debug Log Generated when the Card Authentication Device 31 Reads the Personal Card 32

In FIGS. 8A and 8C, the user name is input by typing of the keys of the key unit 18, but the user name can be authenticated by reading the personal card 32 by the card authentication device 31. The card authentication device 31 is connected to the main body of the image forming apparatus 1 via a USB connector, and in a case where user authentication is performed by an input from the card authentication device 31, the AuthdeviceTask 205 passes the user name to the LoginTask 202 instead of the PanelTask 201. When accepting the input of the user ID from the card authentication device 31, the AuthdeviceTask 205 outputs the debug log indicating the user name passed to the LoginTask 202 using the template 2051 (see FIG. 6A) having the same contents as the PanelTask 201. In a case where garbling or the like occurs in the user name delivered from the card authentication device 31 due to noise or the like, the user name in which the garbling has occurred is converted into a hash value different from any of the user names backed up in the flash ROM 21 as illustrated in the debug log 2210 of FIG. 8D, and thus it can be clearly understood that the garbling has occurred when the user name is input from the card authentication device 31.

(5-3) Debug Log Indicating Email Transmission

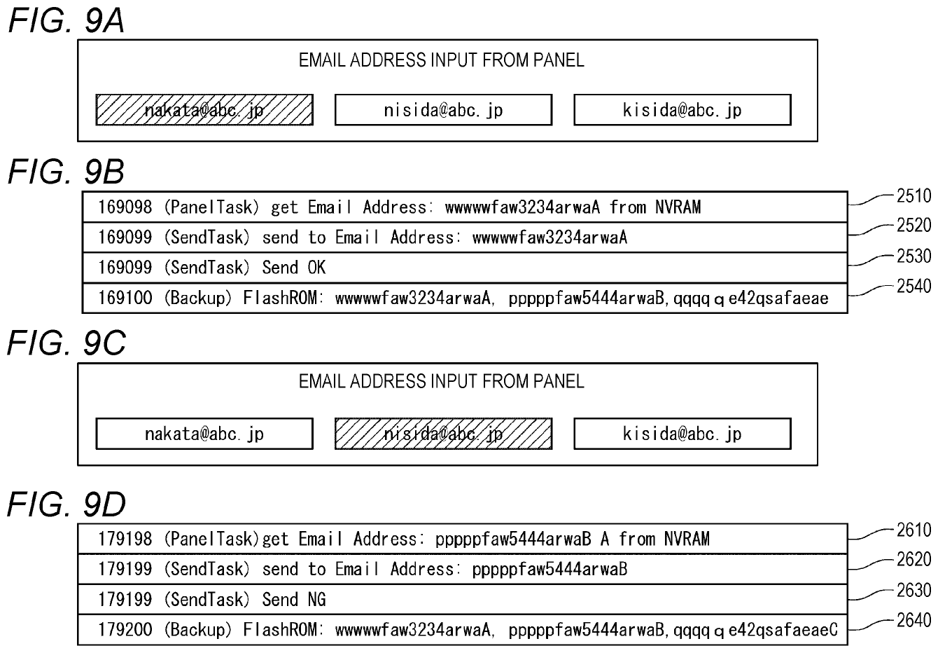

In FIGS. 8A and 8C, the user name is input by typing the keys of the key unit 18, but FIGS. 9A and 9C assume a case where an email address is input by an operation on the email address screen displayed on the display unit 16. The email address screen of FIG. 9A displays a list of email addresses stored in the NVRAM 24, that is, nakata@abc.jp, nisida@abc.jp, and kimura@abc.jp, and receives selection of any email address.

It is assumed that the user selects an email address of nakata@abc.jp among these email addresses. At this time, the PanelTask 201 acquires the coordinates of nakata@abc.jp on the email address screen, and acquires nakata@abc.jp from the NVRAM 24 as the email address corresponding to the coordinates. The PanelTask 201 copies the address of the area in which nakata@abc.jp is stored in the NVRAM 24 to the inter-task communication variable 262, thereby delivering nakata@abc.jp to the SendTask 203.

Since the PanelTask 201 has acquired the email address from the NVRAM 24, the log processing code 214 included in the PanelTask 201 selects the template 2012 that is the second template (step S102).

The log processing code 214 included in the PanelTask 201 acquires the email address of nakata@abc.jp from the NVRAM 24 as a character string to be applied to the portion of [email address variable] of the template 2012 (step S109). The hash value is calculated from the character string acquired in this manner and the random number, and the hash value is applied to the user name variable of the template (step S110). Thus, a debug log 2510 of FIG. 9B, that is, get Email Address: wwwwwfaw3234arwaA from NVRAM is obtained.

It is assumed that the SendTask 203 creates an email addressed to the acquired email address, attaches image data obtained by reading by the scanner unit 12, and transmits the email, and the email reaches the destination. As the log processing code included in the SendTask 203, the template 2031, that is, send to Email Address: [email address variable] Send OK is selected from the two templates corresponding to SendTask (step S102), and the email address of nakata@abc.jp is acquired from the NVRAM 24 as a character string to be applied to the portion of [email address variable] of the template 2031 (step S109). The hash value is calculated from the character string acquired in this manner and the random number, and the hash value is applied to the email address variable of the template 2031 (step S110). Thus, debug logs 2520 and 2530 in FIG. 9B, that is, send to Email Address: wwwwwfaw3234arwaA, Send OK are obtained.

Since email transmission is being executed in the previous task, three email addresses nakata@abc.jp, nisida@abc.jp, and kisida@abc.jp registered in the NVRAM 24 are written to the flash ROM 21 for the BackupTask 204. Since the email address is written in the flash ROM 21, the template 2042 is selected for the BackupTask 204, and the hash value obtained by conversion of the three email addresses is applied to the email address variable of the template 2042 to obtain a debug log 2540 of FIG. 9B, that is, FlashROM: wwwwwfaw3234arwaA, pppppfaw5444arwaB, qqqqqe42qsafaeae.

FIG. 9C illustrates a case where the user is selected as the email address of nisida@abc.jp on the email address screen. At this time, the PanelTask 201 acquires the coordinates of nisida@abc.jp on the email address screen, and acquires the character string nisida@abc.jp from the NVRAM 24 as the email address corresponding to the coordinates. Similarly to the above, the log processing code 214 included in the PanelTask 201 selects the template 2012 and outputs a debug log 2610 in which the hash value of nisida@abcjp is applied to the email address variable of the template 2012, that is, get Email Address: pppppfaw5444arwaB A from NVRAM.

On the other hand, it is assumed that the SendTask 203 creates an email addressed to the acquired email address, attaches image data obtained by reading by the scanner unit 12, and transmits the email, but the email is not delivered. At this time, as the log processing code included in the SendTask 203, the template 2032, that is, send to Email Address: [email address variable] Send NG is selected from the two templates 2031 and 2032 corresponding to the SendTask 203 (step S102). The log processing code 234 included in the Send application 103 acquires the email address nisida@abc.jp from the NVRAM 24 as the character string to be applied to a portion of [email address name variable] of the template 2032 (step S109). A hash value pppppfaw5444arwaB is calculated from the character string acquired in this manner and the random number (step S110), and the hash value is applied to the email address variable of the template 2012 (step S111). Thus, debug logs 2620 and 2630 in FIG. 9D, that is, send to Email Address: pppppfaw5444arwaB and Send NG are obtained. The BackupTask 204 is similar to that in FIG. 9B.

Comparing the debug log 2520 output when the transmission succeeds with the debug log 2620 output when the transmission fails, the hash value output by the SendTask 203 when the transmission fails is the same as one of the hash values written in the NVRAM 24 by the BackupTask 204, and thus it can be understood that the failure of the mail transmission by the SendTask 203 is caused by that the email address registered in the NVRAM 24 is incorrect.

### [6] Summary

As described above, according to the present embodiment, the conversion of the personal data by the hash function has a property of converting a plurality of plaintexts having the same number of characters into different code words, and thus it is possible to distinguish whether or not the hash value included in each of the plurality of debug logs represents the same target. Since it is possible to clearly distinguish whether a negative processing result indicated in the debug log is due to erroneous input by key typing or erroneous input at the time of reading the card, even if the debug log indicates a negative processing result, if it can be found that the negative processing result is due to erroneous input, the processing result can be excluded from the analysis target as not indicating the cause of the bug. Thus, debugging of the program incorporated in the image forming apparatus can be efficiently performed, and the quality of the image forming apparatus can be improved.

### [7] Second Embodiment

In the first embodiment, the personal data in the debug log is replaced with the hash value and output, but the hash value has a large word length, and occupies a large area when the hash value is accumulated in the RAM 22 and output. Accordingly, in the present embodiment, each hash value obtained by replacing the personal data is replaced with a character string (shortened character string) having a shorter word length.

(7-1) Replacement of Shortened Character String Using Table

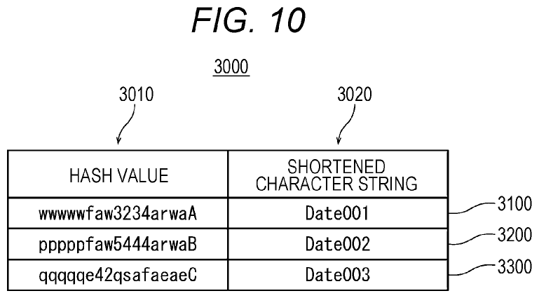

This shortened character string has a format in which a reserved word indicating correspondence to personal data and a numerical value of a predetermined number of digits are combined, and is assigned to each of the plurality of hash values generated in steps S107 and S110 in FIG. 7. For the allocation, a hash value table 3000 as illustrated in FIG. 10 is generated in the RAM 22.

As illustrated in FIG. 10, the hash value table 3000 includes records 3100, 3200, 3300, . . . respectively corresponding to a plurality of hash values. Each record stores the hash value 3010 generated in step S104 and a shortened character string 3020 corresponding thereto.

(7-2) Procedure for Replacement with Shortened Character String

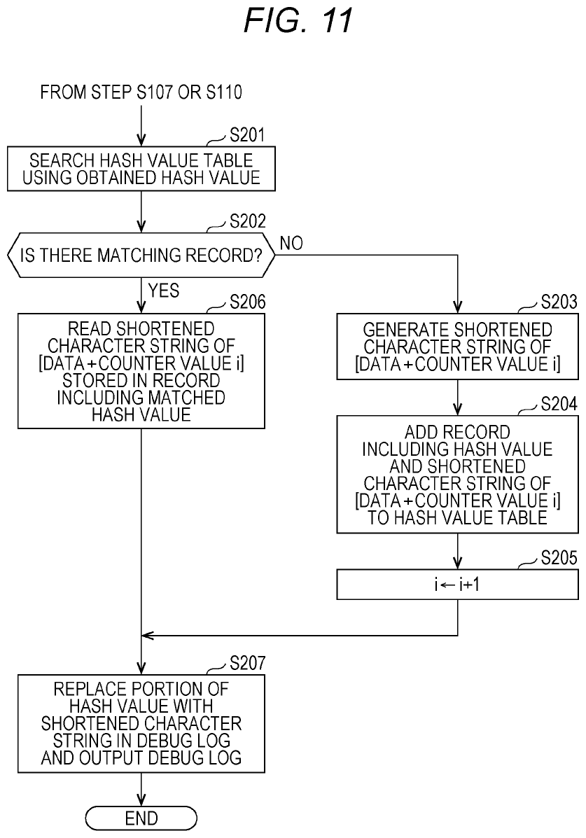

In order to shorten the hash value using such a hash value table 3000, in the second embodiment, steps S201 to S207 of the flowchart illustrated in FIG. 11 are executed instead of steps S108 and S111 after steps S107 and S110 of FIG. 7.

First, the hash value table 3000 is searched using the hash value obtained in step S104 (step S201), and it is determined whether there is a matching record (step S202). If there is no record matching the hash value (No in step S202), a shortened character string of [DATA+counter value i] is generated (step S203), a record including the hash value and the shortened character string of [DATA+counter value i] is added to the hash value table 3000 (step S204), and the variable i is incremented (step S205). When a matched hash value exists in the hash value table 3000 (Yes in step S202), the shortened character string 3020 of [DATA+counter value i] stored in the record including the matched hash value is read (step S206).

When the shortened character string corresponding to the hash value in the debug log is obtained in either step S204 or S206, the portion of the hash value in the debug log is replaced with the shortened character string, and the debug log is output (step S207).

(7-3) Hash Value Replacement in Debug Log Indicating Mail Transmission

As in FIG. 9A, it is assumed that the user inputs one of the email addresses registered in the NVRAM 24 to the operation unit 15. When the Panel application 101 outputs the debug log and replaces the email address of nakata@abc.jp included in the debug log with wwwwwfaw3234arwaA, it is determined that no hash value is registered in the hash value table 3000 (No in step S202) and the hash value of wwwwwfaw3234arwaA is completely new, and a shortened character string of [DATA+counter value i] is assigned to the hash value. Since the counter value i has three digits and i=1, a shortened character string DATA001 is generated as a shortened character string corresponding to the hash value of wwwwwfaw3234arwaA (step S203).

When the Send application 103 outputs the debug log and replaces the email address of nakata@abc.jp included in the debug log with wwwwwfaw3234arwaA, since the same hash value is registered in the hash value table 3000 (Yes in step S202), the hash value of wwwwwfaw3234arwaA included in the debug log is replaced with the shortened character string DATA001, and the debug log is output (step S207).

The Backup application 104 outputs a debug log, and determines whether or not the hash values wwwwwfaw3234arwaA, pppfaw5444arwaB, and qqqqqe42qsafaeaeC included in the debug log are registered in the hash value table 3000. Since the same hash value as wwwwwfaw3234arwaA is registered in the hash value table 3000 (Yes in step S202), the hash value of wwwwwfaw3234arwaA included in the debug log is replaced with the shortened character string DATA001, and the debug log is output. Since pppfaw5444arwaB and qqqqqe42qsafaeaeC are not registered in the table, a shortened character string (DATA002, DATA003) of [DATA+counter value i] is generated as a shortened character string corresponding to these hash values (step S203).

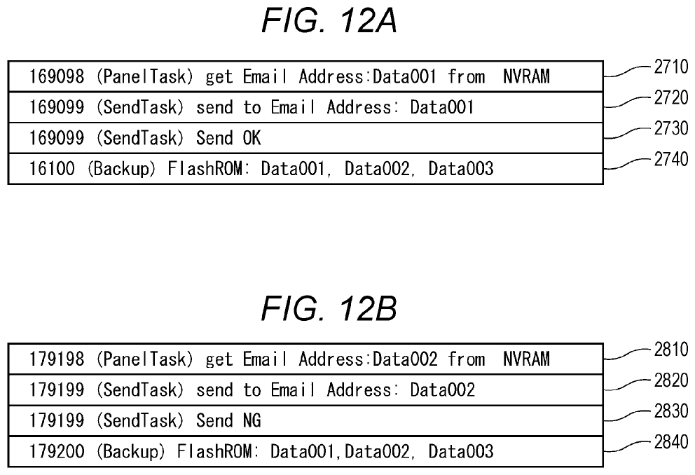

Consequently, the debug logs 2710 to 2740 and the debug logs 2810 to 2830 indicating exchange of the personal data are generated using DATA001 and DATA003 as illustrated in FIGS. 12A and 12B.

(7-4) Summary

In a general business having several tens of staffs, the number of pieces of personal data appearing in the debug log is at most about several hundreds, and it is considered that the number of pieces of personal data appearing in the debug log is less than 1000 in many cases. Each of the pieces of the personal data less than 1000 is converted into the hash value at a ratio of 1:1, and the converted hash value is converted into a character string having a shorter word length. Thus, in the second embodiment, the hash value in a debug log file can be converted into the character string having a short number of characters within a range having no duplication. By being converted into such a short character string, the area occupied by the debug log file in the NVRAM 24 becomes small, and it becomes clear to distinguish which and which correspond to each other, so that it is possible to efficiently perform debugging in the subsequent stage.

### [8] Comparison with Replacement According to JP 2010-147942 A

For reference, a debug log obtained by performing character string replacement according to JP 2010-147942 A is compared with a debug log output by the image forming apparatus 1 of the first embodiment. When the number of unmasked characters is increased, the original character string is more likely to be specified. Thus, if the ratio between the consecutive character strings to be masked and the consecutive character strings not to be masked is not set to about 9:1, the risk of specifying the user name increases. Since NAKATA, NISIDA, and KAWATA each have six characters, it is necessary to mask a portion of five characters as 90% of them.

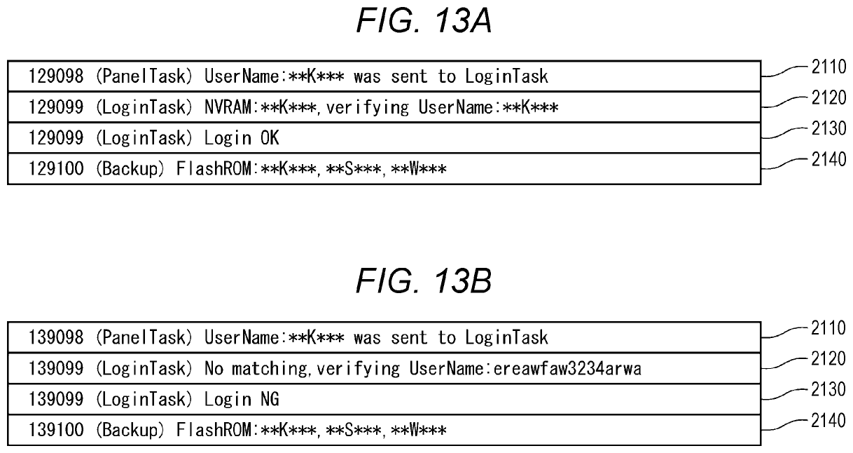

At this time, as illustrated in FIG. 13A, when the third character from the head, that is, the portions of K, S, and W are assumed to be non-masking portions, **K***, **S***, and **W*** are obtained, and these user names are distinguished. Then, data exchange for **K*** between the Panel application 101 and the Login application 102 can be traced. However, in a case where NAKATA is erroneously input as NAKKTA as illustrated in FIG. 8C, even when the names of the three users are distinguished by masks of **K***, **S***, and **W***, as illustrated in FIG. 13B, both NAKATA and NAKKTA become * *K* **, and the error in key input does not appear in the debug log. As described above, in the character string replacement in Japanese Patent Application Laid-Open No. 2010-147942, it is difficult to specify a mask that can distinguish user names having the same number of characters, and even if the user names can be distinguished, the presence or absence of an error in key input cannot be indicated in the debug log. In a case where there is the debug log of Login NG, it is not possible to distinguish whether it is a bug in the Panel application 101 or the Login application 102, a failure in the operation unit 15 or the NVRAM 24, or the user's erroneous input, and extra analysis time is spent for debugging. In contrast, since the image forming apparatus 1 according to the present embodiment replaces NAKATA, NAKKTA, NISIDA, and KAWATA respectively with different hash values, user names of the same character string can be expressed respectively using different hash values, and occurrence of a key input error can be expressed in the debug log.

### [9] Modification Example

Although the present invention has been described on the basis of the embodiments, it is needless to say that the present invention is not limited to the above-described embodiments, and the following modification examples are conceivable.

(1) In the above embodiment, it is desirable to use a complete hash function as a function that is a one-to-one mapping and has a unidirectional property. The complete hash function may be a minimum complete hash function such as Knuth multiplicative hash. However, the hash function may be an incomplete hash function as long as practicality is not impaired.

Although MD5 is used as the hash algorithm, the hash algorithm is not limited thereto. Other hash algorithms may be used. Specifically, the conversion of the personal data may be executed by a hash algorithm in which a part of the following MD5 calculation process is changed.

The personal data and the calculation constant are input to perform processing, and a value of a 128 bit fixed length is output. Padding is performed such that the input message is a multiple of 512 bits (32 bit word is 16).

The main part of MD5 repeats the following processes 1), 2), and 3) for 32 bit words A, B, C, and D.

1) Among A[i], B[i], C[i], and D[i], a series of processes such as conversion by a non-linear function F, addition by modulo 232, and bit rotation to the left is performed on the earliest A[i] to obtain A′[i].

2) The order of D[i], A′[i], B[i], and C[i] is set as A[i+1]=D[i], B[i+1]=A′[i], C[i+1]=B[i], and D[i+1]=C[i].

3) Set A[i+1], B[i+1], C[i+1], and D[i+1] to A[i], B[i], C[i], and D[i], and return to 1). The present invention is not limited to the hash function, and other calculations other than the hash function may be used as long as the function is one-to-one mapping and has a unidirectional property.

(2) The data to be replaced with the hash value is the user name and the email address, but is not limited thereto. If the data corresponds to the personal data of the GDPR, other data needs to be converted into a hash value. For example, data indicating a name, identification number, location data, online identifier (IP address, cookie identifier), physical, physiological, genetic, mental, economic, cultural, and social uniqueness of a natural person must be converted into a hash value.

Data processed as the personal data in the GDPR, that is, customer contacts and customer names, data that can be subjected to employee work evaluation by superiors, names of all employees, and internal job names must be converted into hash values.

Further, in the image forming apparatus, in addition to the processing exemplified in the above embodiment, data related to an issuer of various jobs including a print job, a scan job, a copy job, a facsimile transmission job, a facsimile reception job, and the like may also correspond to the regulation target data and the possible target data. When the data related to the issuer of the various jobs corresponds to the regulation target data or the possible target data, it is desirable to convert the data into the hash value.

(3) In the second embodiment, when the personal data is converted into the hash value, the hash value is further converted into the shortened character string, but the present invention is not limited thereto. The debug log file may be replaced with the shortened character string at the stage of generating the debug log file and delivering the debug log file to the PC 2 of the service person. In addition, the shortened character string is a reserved word+a three-digit numerical value, but this three-digit numerical value may be changed according to the number of staffs of the office. In addition, a dictionary of shortened character strings may be held in advance, and the conversion may be executed by replacing the hash value in the debug log file with a shortened character string in the dictionary. The shortened character string prepared for this shortened character string is desirably a name that is easy for human, such as TARO and HANAKO.

(4) In the first embodiment and the second embodiment, the personal data is uniformly replaced with the hash value, but the present invention is not limited thereto. The registrant of the personal data may be asked to consent to the use of the personal data for debugging purposes, and if consent is obtained, the debug log file in a state including the personal data may be output without converting the hash value. As a method of obtaining the agreement, an email to which the debug log file in the state including the personal data is attached is transmitted to the provider of the registered personal data or the administrator of the image forming apparatus. When a reply indicating agreement with the debugging use is made to the email, the debug log is output without conversion into the hash value.

(5) The possible target data and the regulation target data may include accompanying data stored in the NVRAM 24 accompanying the personal data. As accompanying data stored in the NVRAM 24 accompanying the personal data, there are count value data and personal setting data. The count value data indicates the number of executions of a job performed by the user for each job. The personal setting data indicates sheet setting, duplex setting, document reading setting, print setting, scanning, and FAX destination setting performed by the user on the operation unit 15. The accompanying data may be converted by the hash function.

(6) The random number as the calculation constant is stored in the NVRAM 24 together with the regulation target data, but the present invention is not limited thereto. The data may be stored in a non-volatile medium other than the NVRAM 24. For example, the data may be written in a secure recording medium such as a tamper resistant module and supplied to the image forming apparatus 1. In addition, the periodic backup by the BackupTask 204 is performed by writing to the flash ROM 21, but the present invention is not limited thereto. The backup may be made by writing in the HDD 23 or may be made by writing in a storage of a server connected to a network.

(7) In the above embodiment, the image forming apparatus is an MFP, but the present invention is not limited thereto. The image forming apparatus may be provided in a production printing apparatus. In addition, the image forming apparatus may be a single-function copier or a single-function peripheral device (printer) of a personal computer. Further, the image forming apparatus may be a label printer, a postcard printer, or a ticket issuing machine. Y, M, C, and K color exposure devices and developing devices may be provided to form a color type image forming apparatus, or an exposure device and a developing device for K color may be provided to form a monochrome type image forming apparatus. Exposure devices and developing devices may be provided for two or three colors among Y, M, C, and K colors to form an image forming apparatus in which two or three colors are printed. In addition, the present invention is not limited to the electrophotographic method, but may be an inkjet method.

In the present disclosure, the processing contents performed by the program incorporated in the device can be expressed in the debug log while satisfying the requirements of the legal regulations, and the debugging work by the program developer is greatly improved. Thus, the present disclosure may be used in industrial fields of various business types such as an industrial field of OA equipment and information equipment, a retail industry, a rental industry, a real estate industry, an advertisement industry, a transportation industry, and a publishing industry.

According to an embodiment of the present invention, one-to-one conversion is used, while in the mask processing according to the above-described conventional technology, the argument character string before processing and the argument character string after processing have a many-to-one relationship. Thus, even though pieces of the possible target data before conversion are different from each other, pieces of the conversion result data after conversion are not identical to each other and can be distinguished from each other, and it is possible to avoid deterioration of analyzability by the debug log.

Further, since the one-way conversion is used, it is possible to protect the possible target data that can be a target of legal regulations in the sense that it is difficult to obtain the possible target data before conversion from the conversion result data after conversion.

Although embodiments of the present invention have been described and illustrated in detail, the disclosed embodiments are made for purposes of illustration and example only and not limitation. The scope of the present invention should be interpreted by terms of the appended claims

What is claimed is:

1. An image forming apparatus, comprising:
a converter that applies unidirectional one-to-one conversion to possible target data that has a possibility of becoming a target of legal regulations; and
a log outputter that outputs a debug log including conversion result data obtained by the one-to-one conversion.

2. The image forming apparatus according to claim 1, wherein
the unidirectional one-to-one conversion is conversion using a hash function.

3. The image forming apparatus according to claim 2, further comprising
a constant storage that stores a calculation constant used for calculation of the hash function.

4. The image forming apparatus according to claim 1, further comprising:
a collation converter that obtains collation data for collation with the conversion result data by performing the one-to-one conversion on regulation target data that is a target of legal regulations; and
a collation outputter that outputs collation data.

5. The image forming apparatus according to claim 4, further comprising:
a nonvolatile memory in which the regulation target data is written; and
a backup part that backs up the regulation target data written in the nonvolatile memory to a backup medium, wherein
the collation converter obtains the collation data besides the backup, and the collation outputter outputs the collation data.

6. The image forming apparatus according to claim 5, wherein
the collation converter obtains the collation data from the regulation target data backed up in the backup medium besides the backup.

7. The image forming apparatus according to claim 5, wherein
the backup part periodically performs the backup.

8. The image forming apparatus according to claim 5, wherein
a plurality of pieces of regulation target data is written in the nonvolatile memory, and the plurality of pieces of regulation target data is data indicating a plurality of registered users registered in advance, and
the possible target data is data input by panel operation or data input by reading a card.

9. The image forming apparatus according to claim 5, wherein
a plurality of pieces of regulation target data is written in the nonvolatile memory, and the plurality of pieces of regulation target data is data indicating a plurality of destinations registered in advance, and
the possible target data indicates a destination selected from a plurality of destinations registered in advance.

10. The image forming apparatus according to claim 2, wherein
the unidirectional one-to-one conversion includes a shortened conversion for replacing a hash value obtained by the conversion by the hash function with a shortened word having a short word length.

11. The image forming apparatus according to claim 1, further comprising
a receiver that receives necessity of conversion of the possible target data, wherein
when the conversion is necessary, the converter performs the conversion, and the log outputter performs the output, and
when the conversion is unnecessary, a debug log including the possible target data without change is output.

12. The image forming apparatus according to claim 11, further comprising
a communicator that executes communication for requesting permission from a provider or an administrator of personal data for using the personal data for debugging, wherein
the converter switches whether or not to perform the one-to-one conversion depending on whether or not permission is obtained from a provider or an administrator of the personal data for using the personal data for debugging.

13. A control method, comprising:
applying unidirectional one-to-one conversion to possible target data that has a possibility of becoming a target of legal regulations; and
outputting a debug log including conversion result data obtained by the one-to-one conversion.

14. A non-transitory recording medium storing a computer readable program causing a computer to perform:
applying unidirectional one-to-one conversion to possible target data that has a possibility of becoming a target of legal regulations; and
outputting a debug log including conversion result data obtained by the one-to-one conversion.
